(19) United States
(12) Patent Application Publication
(10) Pub. No.: US 2005/0190904 A1
(43) Pub. Date: Sep. 1, 2005

(54) Method for performing network-based telephone user identification

(76) Inventors: Vinod Anupam, Bridgewater, NJ (US); Markus Andreas Hofmann, Fair Haven, NJ (US)

Correspondence Address: Docket Administrator (Room 3J-219);Lucent Technologies Inc., 101 Crawfords Corner Road, Holmdel, NJ, 07733-3030, US

(21) Appl. No.: 10/788,201

(22) Filed: Feb. 26, 2004

(51) Int. Cl. H04M 15/00; H04M 1/56; H04M 15/06; H04M 3/42

(52) U.S. Cl. 379/142.05; 379/142.06; 455/415

(57) ABSTRACT

A network-based approach to calling user identification (Calling-user ID). A users identifies and authenticates himself directly to the telephone network. Each user is assigned a preferably unique identifier by a service provider. Before a user places a call, he identifies himself to the telephone network with use of the assigned identifier and authenticates his identity with use of a previously selected PIN (Personal Identification Number). When the user dials the call, the network propagates the saved user identification information corresponding to the provided identifier using the same conventional process used in prior art “Caller ID” systems for providing calling device information. Various telephony services including a service for providing the calling user identification to the called party (Calling-user ID), can then advantageously utilize this information.

### FIELD OF THE INVENTION

The present invention relates generally to the field of telecommunications and more particularly to a method for providing network-based identification (e.g., to a called party) of a telephone user (e.g., a particular individual caller).

### BACKGROUND OF THE INVENTION

The notion of Caller ID is well understood in the telephone network. Specifically, “Caller ID” is the identification of the originating subscriber line, typically to the receiver of the call (i.e., the “called party” or the “callee”). When a user makes a phone call, the calling line's phone number is passed from the caller's central office to the callee's central office over the SS7 signaling network. (The SS7 signaling network is the conventional network/protocol used to administrate all telephone calls, and is fully familiar to those of ordinary skill in the art.) Then, the central office transmits this information to the callee's device. Thus, the callee receives calling device (i.e., line) information which may, for example, be displayed to the callee using conventional equipment.

Though certainly useful, the calling device identification provided to the called party by conventional Caller ID techniques is of more limited use than calling user identification might be. (Calling user identification to the called party will be referred to herein as “Calling-user ID”) That is, a callee would actually prefer to know the identity of the person that is calling, rather than merely the identity of the telephone line from which the call is being placed. Moreover, a variety of potentially useful telephony services could be enabled or enhanced by knowing who was calling, as opposed to merely which line or device was being used to make the call. For example, privacy management services and “find-me/follow-me” type services could be customized so particular callers, irrespective of the device they are using, could always get through to a subscriber.

One existing prior art solution to this user identification problem involves the use of callee managed PINs (Personal Identification Numbers). In such an approach, the subscriber typically assigns a PIN to every potential caller to whom he wishes to grant privileged access. Then, when a caller calls the subscriber, the service prompts him for a PIN, collects this information, and uses it to determine how the caller is treated. However, one major problem with PIN based solutions is that of manageability—every user needs to remember PINs for everyone (having such a service) that he calls, and every subscriber needs to assign them for everyone that can call him. Obviously, this does not scale to large numbers of users and subscribers.

### SUMMARY OF THE INVENTION

In accordance with the principles of the present invention, a network-based approach to user identification (and/or authorization) is employed. In particular, instead of identifying themselves to the callee (by using the PIN they were assigned by the callee), users advantageously identify, and optionally, authenticate, themselves directly to the telephone network. For example, in accordance with certain illustrative embodiments of the present invention, each user is assigned a preferably unique identifier by a service provider. Then, before the given user places a call, he or she identifies him- or herself to the telephone network (e.g., with use of the assigned identifier). In accordance with one illustrative embodiment of the present invention, the user further authenticates his or her identity to the network with use of a previously assigned or selected PIN (Personal Identification Number).

### BRIEF DESCRIPTION OF THE DRAWINGS

FIG. 1 shows a flowchart of an illustrative method for use by a telephone user for providing telephone user identification to a telephone network in accordance with an illustrative embodiment of the present invention.

FIG. 2 shows a flowchart of an illustrative method for use in a telephone network for providing network-based telephone user identification in accordance with an illustrative embodiment of the present invention.

### DETAILED DESCRIPTION OF THE ILLUSTRATIVE EMBODIMENTS

In accordance with one illustrative implementation of the present invention, each user is assigned an identifier by a service provider. Illustratively, this identifier may take the form of a conventional e-mail address, or it may take the form of a conventional telephone number which may, for example, have been augmented to differentiate among multiple users of the same number. In the first case, for example, john.doe@service-provider.com might be the identifier assigned by a service provider named “service-provider” to a person who is named John Doe. In the second case, for example, the identifier assigned to the person may be “54-908-555-1212,” where the last ten digits of the identifier are the person's (e.g., home) telephone number and the first two digits (“54”) are used to differentiate among the user's of the number (e.g., residents in the given home).

In addition, each user is advantageously assigned (or preferably, is allowed to choose and subsequently administer) a PIN (Personal Identification Number), which is typically kept “secret” (i.e., known only to the given user. and to the service provider). Then, before the user places a telephone call, he or she can (e.g., optionally) choose to identify themselves to the network by first indicating that they wish to do so, and then providing both their identifier (for user identification purposes) as well as their PIN (for user authentication purposes—i.e., to verify their claimed identity to the service provider ).

Preferably, the network maintains a database which comprises all of the assigned identifiers along with the associated PINs which have been established therefore. Advantageously, the database is organized in a manner which provides for efficient lookups of any provided identifier and its associated PIN. Such database technology is conventional and will be obvious to those skilled in the art.

In accordance with the illustrative embodiment of the present invention, when a user dials a call, after having provided (and authenticated) his or her identity, the network propagates the saved user identification information corresponding to the provided identifier using the same conventional process as is used in prior art “caller ID” systems for calling device information. Illustratively, the saved user information corresponding to each identifier may comprise merely the user's name. In this manner, the called party's central office advantageously receives not only calling device information, as in conventional “Caller ID” functionality, but also, in accordance with the principles of the present invention, calling user identification. Various telephony services, such as, for example, a service for providing the calling user identification to the called party (Calling-user ID), can then advantageously utilize this information.

Note that in accordance with one illustrative embodiment of the present invention, users without identities and users who do not wish to identify themselves can continue to use the phone network as usual. Obviously, in this case, the caller will not receive any user identification, and telephony services will continue to behave as they presently do.

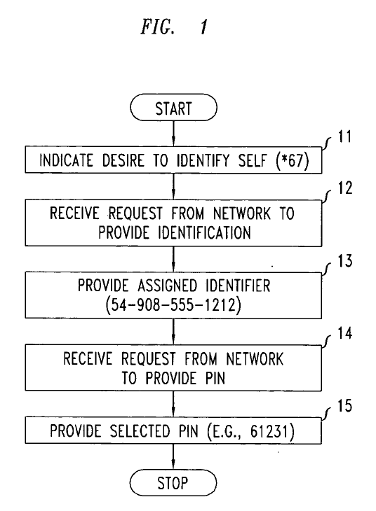

FIG. 1 shows a flowchart of an illustrative method for use by a telephone user for providing telephone user identification to a telephone network in accordance with an illustrative embodiment of the present invention. First, as shown in block 11 of the flowchart, the user provides an indication to the network that he or she wishes to identify him- or herself. For example, the user might press the keys “*67” on the telephone keypad (assuming that *67 is an otherwise unused network control code) to express the fact he or she wishes to provide his or her identification. Then, as shown in block 12 of the flowchart, the user receives a request from the central office (i.e., the network) to provide his or her previously assigned identifier.

In response to the network's request, the user then provides his or her assigned identifier (e.g., 54-908-555-1212) by pressing the corresponding keys on the telephone keypad, as shown in block 13 of the flowchart. (Note that other mechanisms for communicating the user's assigned identifier will be obvious to those of ordinary skill in the art, including when the assigned identifier comprises alphanumeric, rather than purely numeric characters.) Next, as shown in block 14 of the flowchart, the user receives a request from the central office (i.e., the network) to enter his or her PIN (Personal Identification Number).

Finally, as shown in block 15 of the flowchart, the user enters the PIN that he or she established with the service provider—for example, the users presses the keys “61231” on the telephone keypad. Assuming that the central office is able to match the provided identifier to one stored in its internal database, and assuming that it is further able to authenticate the user (based on the supplied PIN matching the one which has been established for and associated with the given identifier), the user information is saved within the network and available for use by applicable telephony services such as, for example, Calling-user ID.

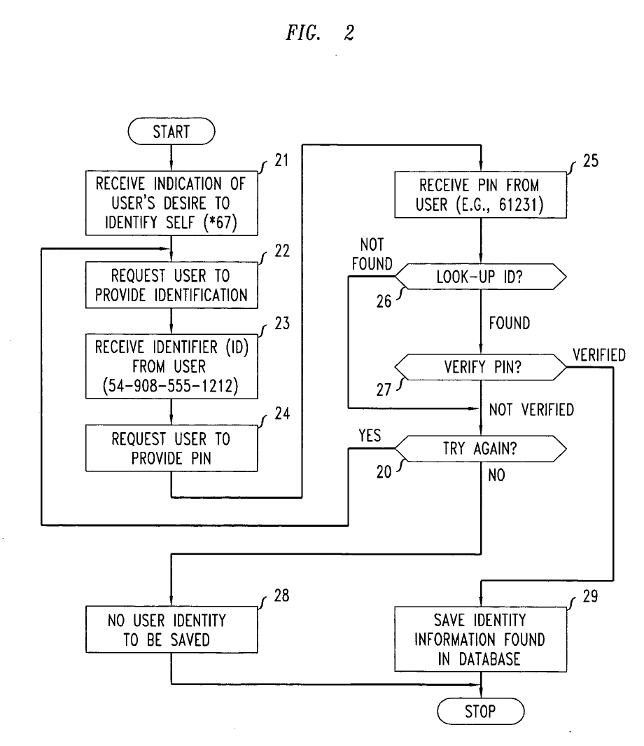

FIG. 2 shows a flowchart of an illustrative method for use in a telephone network (e.g., at a central office) for providing network-based telephone user identification in accordance with an illustrative embodiment of the present invention. First, as shown in block 21 of the flowchart, the central office receives an indication from the user that he or she wishes to identify him- or herself. For example, the user might press the keys “*67” on the telephone keypad (assuming that *67 is an otherwise unused control code to the network) to express the fact he or she wishes to provide his or her identification. Then, as shown in block 22 of the flowchart, the central office requests that the user provide his or her previously assigned identifier.

In response to this request, the central office then receives the user's assigned identifier (e.g., 54-908-555-1212), as shown in block 23 of the flowchart. This identifier may, for example, have been provided by the user by pressing the corresponding keys on the telephone keypad. (Note that other mechanisms which the user may have employed to communicate the assigned identifier will be obvious to those of ordinary skill in the art, including when the assigned identifier comprises alphanumeric, rather than purely numeric characters.) Next, as shown in block 24 of the flowchart, the central office requests the user to enter his or her PIN (Personal Identification Number).

Next, as shown in block 25 of the flowchart, the central office receives the user's PIN—the Personal Identification Number that he or she established with the service provider. This PIN may, for example, have been provided by the user by pressing the corresponding keys (e.g., “61231”) on the telephone keypad. Then, as shown in decision box 26 of the flowchart, the central office looks up the provided identifier in its internal database and if it is found, compares the associated PIN (stored along with the identifier in the database) with the received PIN, as shown in decision box 27 of the flowchart.

If either the identifier is not found, or if the identifier is found but the received PIN fails to matched the associated PIN stored in the database, the user is advantageously asked (decision box 20 of the flowchart) if he or she wants to enter the information again (i.e., the information may have been incorrectly entered). If so, flow returns to block 22 of the flowchart to enable the user identifier and the PIN to be reentered by the user. Otherwise, the central office cannot authenticate (i.e., identify) the user and no user identity is saved (or, therefore, associated with any calls being made or to be made), as shown in block 28 of the flowchart.

If, however, the identifier is located by the central office in the database and moreover, the identity of the user is authenticated by finding that the received PIN matches the PIN associated with (stored along with) the identifier in the database, then the user identity information is saved within the network (as shown in block 29 of the flowchart). This stored information (i.e., the calling user ID information) is then advantageously saved for (at least) the remainder of the call that the user next makes, and thus, this user identity information will be fully available for use by any applicable telephony services encountered throughout the call, such as, for example, Calling-user ID.

The illustrative embodiments of the present invention described above assumes that a caller would need to identify him- or herself every time he or she makes a call. However, in accordance with other illustrative embodiments of the present invention, a “sticky” authorization is implemented whereby a user advantageously authenticates himself in a manner which “binds” his or her identity to a given device (e.g., telephone) or telephone line. For example, the user may provide his or her identity information (identifier and PIN) preceded by a different network control code (e.g., “*68” rather than “*67”), which indicates to the network that he or she wishes his or her user information to be bound to the device or line being used either for a fixed, user-specified amount of time (e.g., 1 hour, 1 day, etc.), or, alternatively, until it is explicitly un-bound by, for example, using another network control code (e.g., “*69”). Note that advantageously, the one-time authentication described earlier and this “sticky” authentication approach could co-exist.

In accordance with other illustrative embodiments of the present invention, “delayed authentication” may be provided by the user. That is, in such embodiments the caller need not identify him- or herself and authenticate that identification “up front.” Rather, if and when the caller encounters a service that requires (or merely desires) identity information, the network can at that time prompt the user to identify him- or herself. In accordance with these illustrative embodiments of the invention, callers are advantageously prompted for identity and authentication information only if it is needed.

Note that the concept of user identity as employed herein is not necessarily associated with that of a subscriber to a service provider. Thus, in accordance with other illustrative embodiments of the present invention, the identity provider need not be a telephony service provider at all. And since identity will advantageously be federated, with different identity providers managing different domains, service providers may, in accordance with certain illustrative embodiments of the invention, choose to outsource the identity service to a hosted service provider.

Addendum to the Detailed Description

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. Furthermore, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

Thus, for example, it will be appreciated by those skilled in the art that any flow charts, flow diagrams, state transition diagrams, pseudocode, and the like represent various processes which may be substantially represented in computer readable medium and so executed by a computer or processor, whether or not such computer or processor is explicitly shown. Thus, the blocks shown, for example, in such flowcharts may be understood as potentially representing physical elements, which may, for example, be expressed in the instant claims as means for specifying particular functions such as are described in the flowchart blocks. Moreover, such flowchart blocks may also be understood as representing physical signals or stored physical data, which may, for example, be comprised in such aforementioned computer readable medium such as disc or semiconductor storage devices.

1. A method for providing a telecommunication service based upon calling user identification information, the method implemented in a telecommunications network and comprising the steps of:
receiving calling user identification information from a user of a telecommunications device, the telecommunications device connected to the telecommunications network and associated with a network subscriber line, said calling user identification information comprising information representative of a personal identity of said calling user, said personal identity of said calling user not being equivalent to an identity of the telecommunications device and not being equivalent to an identity of the network subscriber line; and
transmitting said received calling user identification information through said telecommunications network to provide a telecommunication service based thereupon.

2. The method of claim 1 further comprising the steps of:
receiving from said user a Personal Identification Number, said calling user identification information having been previously associated with a stored Personal Identification Number; and
verifying that said received Personal Identification Number is equal to said stored Personal Identification Number.

3. The method of claim 2 wherein said telecommunications network comprises a database having a plurality of user identifiers and associated Personal Identification Numbers stored therein, and wherein said step of verifying that said received Personal Identification Number is equal to said stored Personal Identification Number comprises:
performing a look up of said received user identification information in said database,
locating one of said stored user identifiers in said database which is equal to said received user identification information, and
comparing the stored Personal Identification Number associated with the located one of said stored user identifiers with the received Personal Identification Number and verifying that they match.

4. The method of claim 1 further comprising the step of receiving an indication from the user requesting that said user identification information be received and transmitted.

5. The method of claim 1 further comprising the steps of:
receiving from said user one or more requests to initiate a call from said network subscriber line to one or more corresponding specified called telephone lines, and
initiating said one or more requested calls to said one or more corresponding called telephone lines.

6. The method of claim 5 further comprising the step of receiving an indication from the user requesting that said received user identification information is to be transmitted in connection with a first one of said one or more requested calls and not to be transmitted in connection with any other ones of said one or more requested calls subsequent thereto.

7. The method of claim 5 further comprising the step of receiving an indication from the user requesting that said received user identification information is to be transmitted in connection with all of said one or more requested calls until a contrary indication is received.

8. The method of claim 5 further comprising the step of receiving an indication from the user requesting that said received user identification information is to be transmitted in connection with all of said one or more requested calls until a specified period of time has elapsed.

9. The method of claim 5 further comprising the step of requesting said calling user identification information from said user in response to a request for said calling user identification information from a telecommunications service.

10. The method of claim 5 wherein said telecommunications service based upon said received user calling information comprises providing calling user identity information to called telephone lines, and wherein said step of transmitting said received calling user identification information through said telecommunications network comprises providing said received calling user identification information to at least one of said called telephone lines.
